(19) United States
(12) Patent Application Publication
(10) Pub. No.: US 2005/0079240 A1
(43) Pub. Date: Apr. 14, 2005

(54) Device for forming preformed annular blanks of plastic material, and the relative plant

(75) Inventors: Danilo Albonetti, Imola Bologna (IT); Maurizio Borgatti, Imola (IT)

Correspondence Address: BROWDY AND NEIMARK, P.L.L.C.;624 NINTH STREET, NW, SUITE 300, WASHINGTON, DC, 20001-5303, US

(73) Assignee: SACMI-COOPERATIVA MECCAMICI IMOLA-SOC. COOP. A R.L., Imola, Bologna (IT)

(21) Appl. No.: 10/496,638

(22) PCT Filed: Dec. 3, 2002
(86) PCT No.: PCT/EP02/13644

(30) Foreign Application Priority Data
Dec. 7, 2001 (IT) RE2001A000117

(51) Int. Cl. B26D 3/16

(52) U.S. Cl. 425/311; 425/313

(57) ABSTRACT

For forming annular blanks, a device arranged to cut rings of predetermined thickness from an extruded tube of synthetic material comprising, above the exit mouth of the extruder, a movable body which supports at least one fixed rear knife and at least one knife movable between a working position in which it interacts with the inner edge of a portion of said tube and a rest position in which it is distant from said edge.

### TECHNICAL FIELD

This invention relates to a device for forming synthetic material blanks for subsequent use in compression moulds for moulding the finished product, and to the plant on which said device is installed. In particular, the blanks preformed by the invention are of annular shape and are used, for example, to form the heads of dispensers of flexible tube type.

### BACKGROUND ART

A plant of known type is fully described in U.S. Pat. No. 4,352,775, to the text of which reference should be made for a complete description. In the plant described in the U.S. patent the annular blank is formed by a synthetic material tube extruder, with the extrusion mouth of which there is associated a translating valve element arranged to close the said mouth in such a manner as to cut rings of predefined thickness from said tube.

The productivity of the plant is limited by the time required to form a blank, this depending on the extrusion rate of said flexible tube and the time employed by said valve element to close the extruder mouth in order to cut the ring.

The object of this invention is to provide a device for forming annular blanks of plastic material of high hourly productivity, in which the time employed to form the annular blank is minimal.

### DISCLOSURE OF THE INVENTION

The invention attains this and further objects by a device the characteristics of which are defined in the claims. Specifically, the device of the invention comprises, above an extruded tube of synthetic material, a movable body which supports at least one fixed knife and at least one knife movable between a working position in which it interacts with the inner edge of said tube and a rest position in which it is distant from said edge, said movable knife being operated by suitable means of pneumatic and/or mechanical type.

Said movable body is associated with means for rotating it about a vertical axis external to the body itself. Preferably said means comprise a rotating plate supporting a plurality of devices according to the invention disposed in proximity to the edge of said plate and mutually equidistant. Said plate is maintained in rotation by a drive unit above an extruder which extrudes a tube of synthetic material from which the blanks are formed by the devices of the invention. Angularly spaced from said extruder there is provided a receiving means into which the formed blanks or rings are made to fall. Said receiving means can consist of a simple collection bin or of one of the parts of the forming mould for the product to be produced.

The rings are made to fall into said receiving means by means, preferably of pneumatic type, with which the device of the invention is provided.

The operational and constructional characteristics of the invention will be more apparent from the ensuing description of a preferred embodiment thereof, given by way of non-limiting example and illustrated in the accompanying drawings.

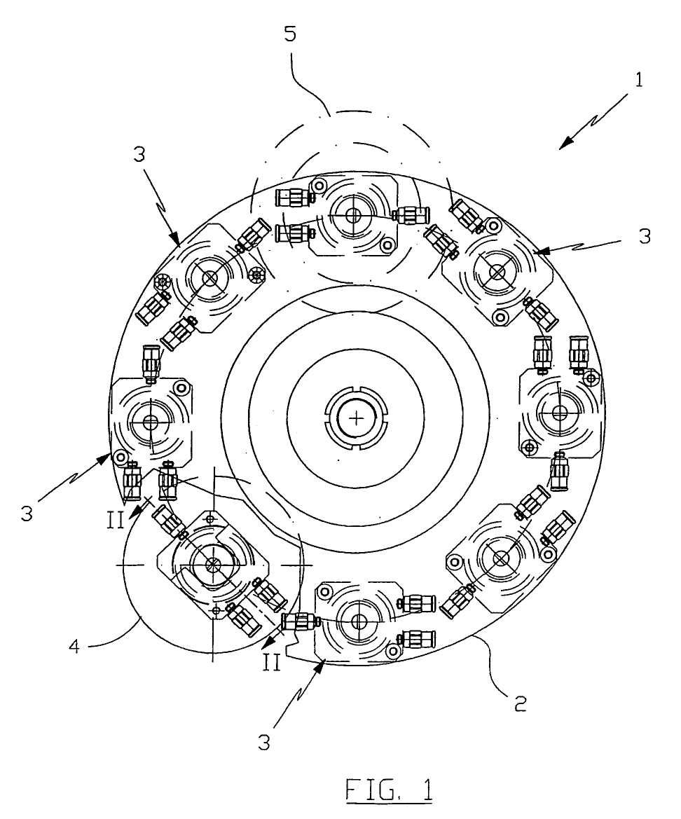

FIG. 1 is a schematic plan view of the plant on which the device of the invention is installed.

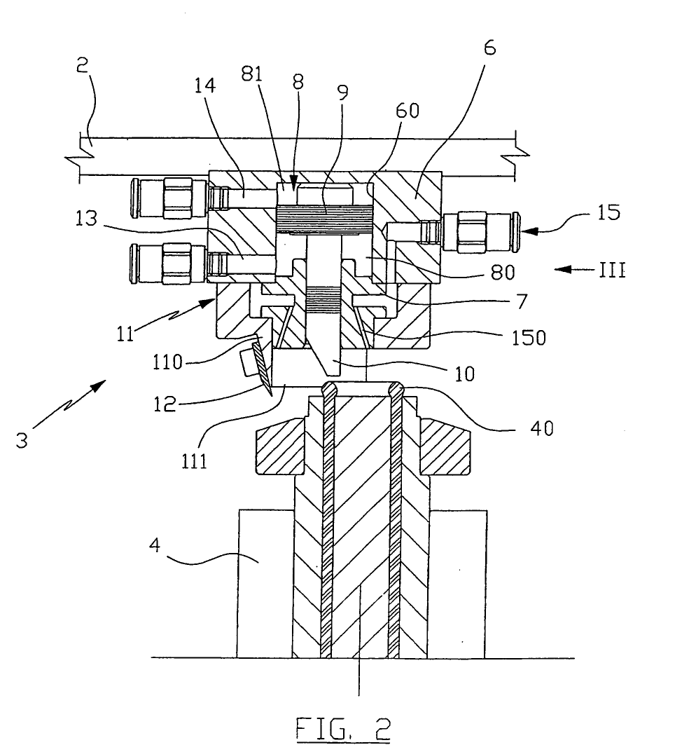

FIG. 2 shows the section II-II of FIG. 1.

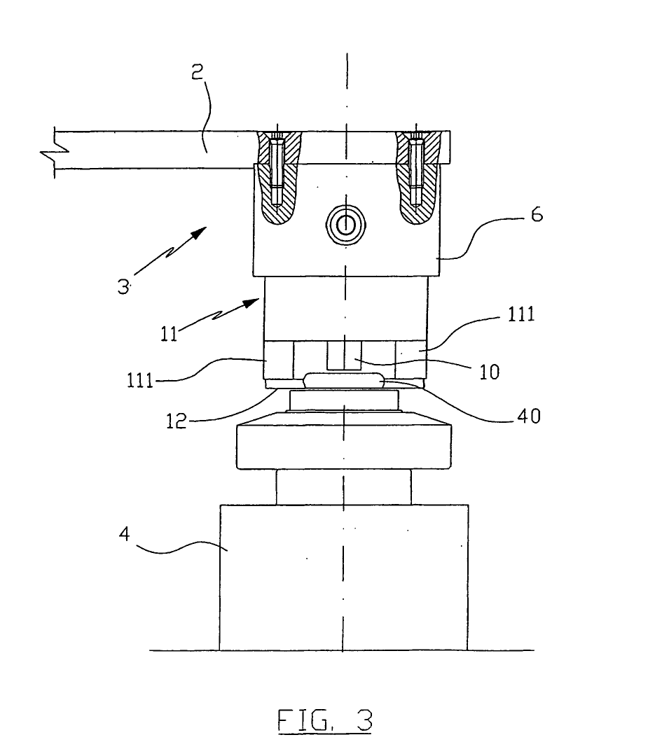

FIG. 3 is a view from III of FIG. 2.

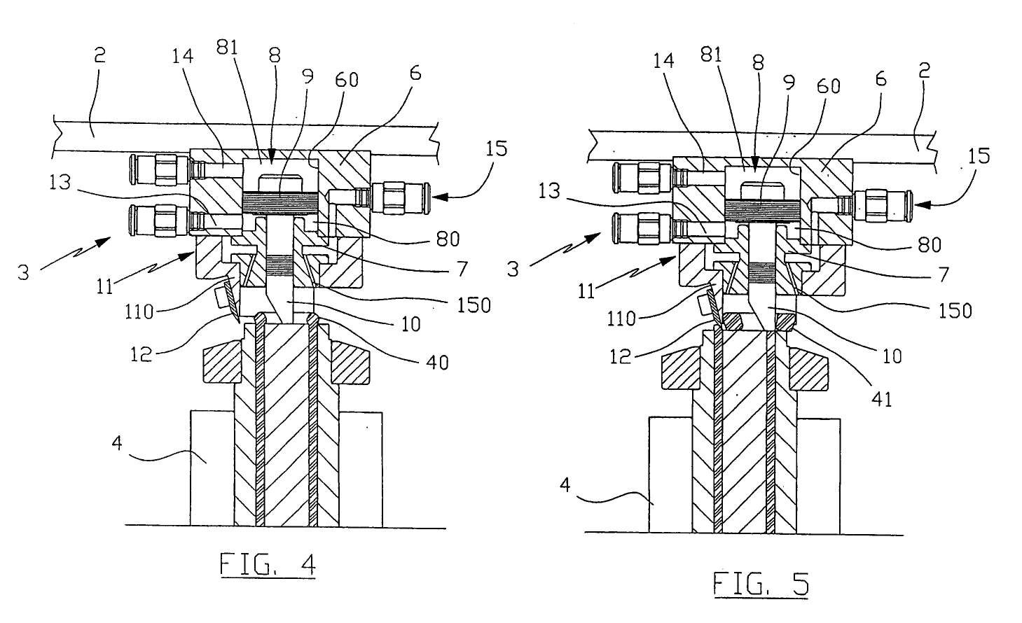

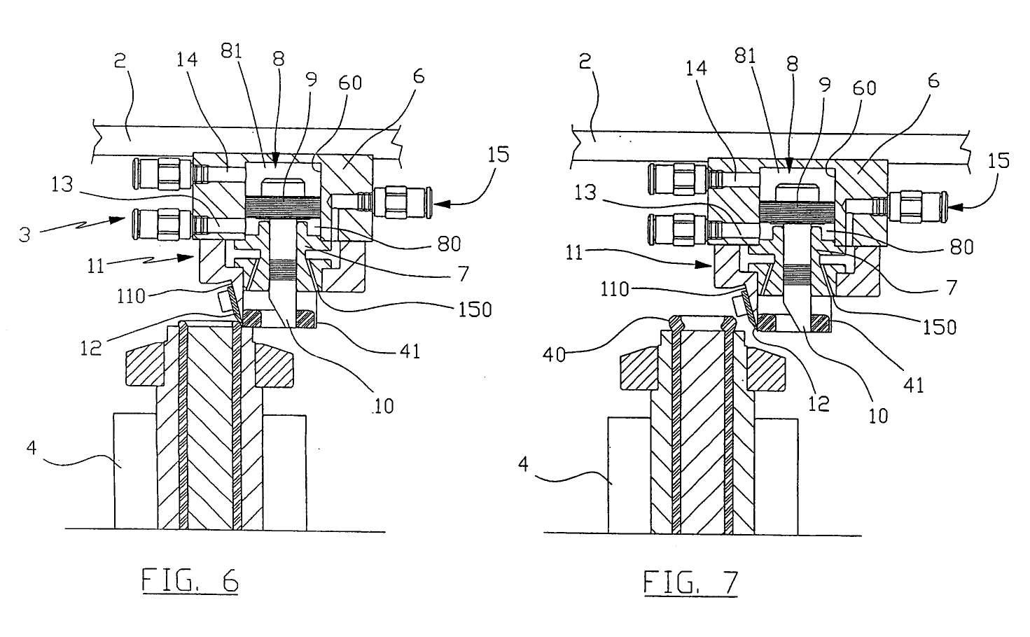

FIGS. 4, 5, 6 and 7 show FIG. 2 of the invention in its various operative stages.

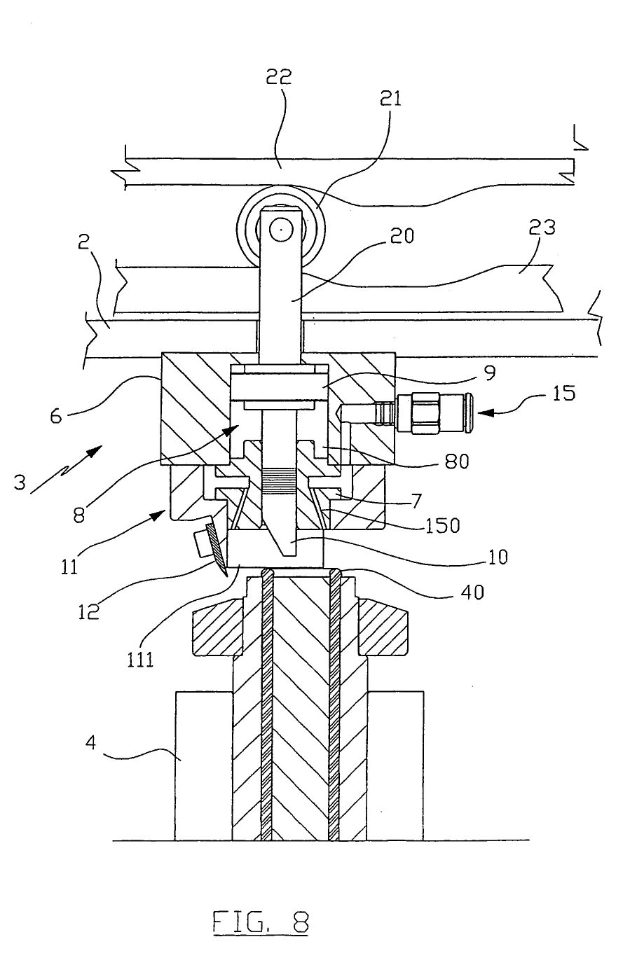

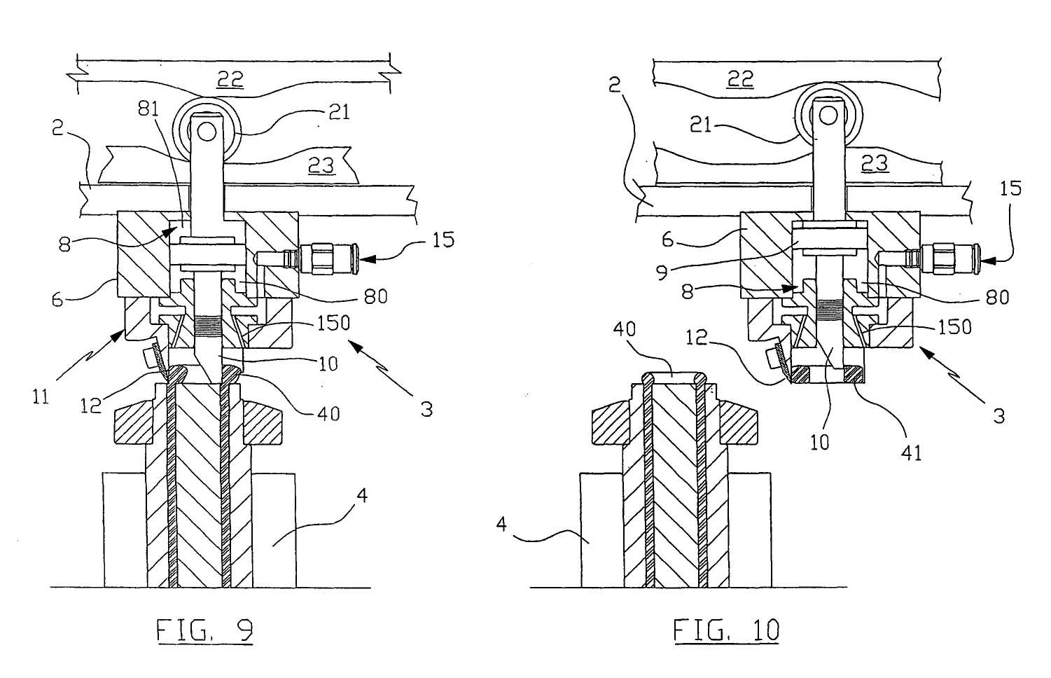

FIGS. 8, 9, 10 show a first variant of the invention.

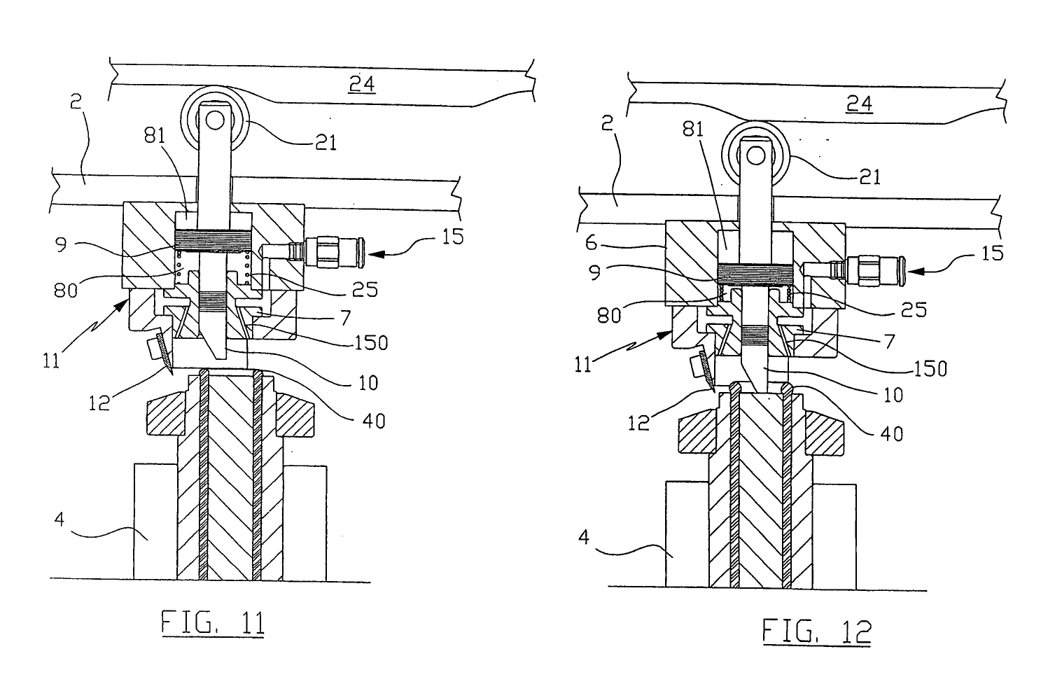

FIGS. 11 and 12 are a section through a further variant of the invention.

FIG. 1 shows a plant 1 of the turntable type comprising a plate 2 which is maintained in rotation by a suitable drive unit, not shown. The plate 2 supports, for forming annular blanks of synthetic material, a plurality of devices 3 disposed circumferentially in proximity to the plate edge, and are angularly equidistant apart. Below said plate there is positioned the extruder 4, of vertical axis, for extruding a tube 40 of synthetic material, from which said devices 3 cut rings 41 of predefined axial dimension, constituting the annular blanks. These annular blanks (or rings) 41 are then deposited, one at a time, into a suitable receiving means 5 (FIG. 1).

This receiving means can be either a collection bin or one of the parts of the forming mould for the product to be produced.

With reference to FIG. 2, each of said devices 3 comprises a body 6, provided with an annular cavity 60 the mouth of which is closed by a lower plug 7 maintained pressed against the mouth of the cavity 60 by a second body 11 fixed to the underside of the body 6 by screws, not shown. Said body 11 comprises a rear wall 110 to which a fixed knife 12 is secured, and two side walls 111.

The inner walls of the cavity 60 and the upper surface of the plug 7 define a chamber 8 within which there slides a piston 9 which divides the internal volume of the chamber 8 into two chambers 80 and 81. The piston 9 is connected to a movable knife 10 which slides within an axial hole in the plug 7 and presents at its lower end a tapered portion which emerges below the plug between the side walls 111 and the rear wall 110 of the body 11.

The movable knife 10 can be positioned between a lowered working position in which, as shown in FIGS. 4, 5, 6 and 7, it cuts that portion of the tube 40 which emerges from the extruder, and a raised rest position in which it is distant from said portion.

With reference to FIGS. 1-7, the movable knife is driven between the two aforesaid positions by means of pneumatic type comprising two conduits 13 and 14 for the feed and return of a pressurized fluid, generally air, which open respectively into the chambers 80 and 81 connected to a usual device for delivery/intake of the pressurized fluid.

Each of the devices 3 is also provided with a pneumatic system for detaching the annular blanks formed.

This system 15 comprises a plurality of pressurized air delivery conduits 150 connected to a usual delivery device, not shown, which are provided respectively within the interior of the upper body, within the interior of the plug 7, and between the plug 7 and the lower body 11.

The operation of the invention is controlled by a processor in the following manner.

With reference to FIGS. 2, 4, 5, 6, 7, when the rotating plate 2 brings the movable knife 10 of the devices 3 above the central channel of the tube 40, the processor causes pressurized fluid to be fed into the chamber 81 to cause lowering of the movable knife 10 (FIG. 4), which becomes inserted into the interior of the tube 40 projecting from the extruder 4. As it continues to rotate, the plate 2 urges the knife 10 against the inner wall of the tube, and the knife begins to cut through a portion of said tube 40. Simultaneously the fixed knife 12 cuts through the rear part of the tube to hence cut off a ring of synthetic material constituting the preformed annular blank to be used in the subsequent moulding of the product. When the ring 41 has been cut off it remains attached to the two knives 10 and 12 while the plate continues to rotate, When the device 3 lies above the receiving means 5, the processor causes pressurized air to be expelled through the conduits 150, so that the ring 41 falls into said receiving means 5.

The processor then causes the movable knife 12 to rise by feeding pressurized fluid into the chamber 80 while at the same time releasing the pressurized fluid contained in the chamber 81.

Two variants of the invention, shown respectively in FIGS. 8, 9 and 10 and in FIGS. 11 and 12 will now be described, these differing from that already described in terms of the drive means for the movable knife of the device 3. In the description and in the accompanying figures, those components already described in the first embodiment of the invention are indicated by the same reference numerals.

FIGS. 8, 9 and 10 show a first variant of the invention in which the knife is driven by means of mechanical type.

Specifically, the upper body 6 of the device 3 and the plate 2 are provided with a hole through which there passes a rod 20 provided at its upper end with a cam follower roller 21 which slides between two fixed cup cams 22 and 23 fixed to the machine bed and positioned above the plate 2. The lower end of the rod 20 is connected to the piston 9 supporting the movable knife 10, which in this case only acts as a guide.

As can be seen from FIG. 8, when the device 3 lies in proximity to the extruder 4, the contours of the cams 22 and 23 are shaped such as to cause the movable knife 10 to descend and enter the interior of the tubular element 40. The rotation of the plate 2 causes the device to rotate and translate so that its knives 10 and 12 cut from said tube 40 a ring 41 of predetermined dimensions, which forms the preformed blank to be subsequently used in forming the product.

The ring 41 is discharged into the mean 5 by expelling pressurized air through the conduits 150, so that the ring 41 falls into said receiving mean 5.

FIGS. 11 and 12 show a further variant of the invention again concerning the drive means for the movable knife.

In this variant, above the rotating plate 2 there is provided only one cam 24, namely the upper cam, against which the roller 21 is maintained pressed by an elastic means situated in the interior of the chamber 8. In particular said elastic means comprises a spring 25 one end of which rests against the upper surface of the plug 7, whereas its opposite end rests against the lower surface of the piston 9, so constantly maintaining the roller 21 pressed against the contour of the cam.

The operation of this further variant is totally identical to that described for the first variant.

Finally in another variant of the invention, not shown, the knife is lowered by means of pneumatic type connected to a conduit which opens into the chamber 81, said means being identical to the already described means 13. In contrast, the knife is raised by a spring identical to the spring 25 and located in the same position, i.e. in the chamber 80.

The invention is not limited to that illustrated and described, but also includes all technical equivalents of the invention, and their combinations, if implemented within the context of the following claims.

1. For forming annular blanks, a device arranged to cut rings (41) of predetermined thickness from an extruded tube (40) of synthetic material, characterised by comprising, above the exit mouth of the extruder (40), a movable body (6) which supports at least one fixed rear knife (12) and at least one knife (10) movable between a working position in which it interacts with the inner edge of a portion of said tube (41) and a rest position in which it is distant from said edge.

2. A device as claimed in claim 1, characterised in that when in said working position said movable knife (10) is in contact with the surface of said extruder.

3. A device as claimed in claim 1, characterised in that when in said working position said movable knife (10) lies in proximity to the surface of said extruder.

4. A device as claimed in claim 1, characterised in that said movable body (6) comprises a cylindrical chamber (8) within which there slides a piston (9) with which said movable knife (10) is associated, the lower end of this latter emerging from a central hole present in the base of said chamber (8).

5. A device as claimed in claim 4, characterised in that said chamber (8) consists of a cavity (60) provided in said movable body (6) and having its mouth closed by a lower plug (7).

6. A device as claimed in claim 1, characterised in that said fixed knife (12) is supported by a second body (11) rigid with said movable body (6).

7. A device as claimed in claim 1, characterised in that said movable knife (10) is driven between its working position and its rest position by means of pneumatic type.

8. A device as claimed in claim 7, characterised in that said means of pneumatic type comprise at least two pressurized fluid feed conduits (13, 14) provided in said movable body (6) and opening respectively above and below said piston (9), they being connected to a suitable fluid delivery device.

9. A device as claimed in claim 1, characterised in that said movable knife (10) is driven between its working position and its rest position by means of mechanical type.

10. A device as claimed in claim 9, characterised in that said means of mechanical type comprise a rod (20) rigid with said piston and emerging upperly from said chamber (8) to support an idle cam follower roller (21) which slides between two overlying profiled cams, the matching contours of which determine the vertical translation of the rod (20).

11. A device as claimed in claim 9, characterised in that said means of mechanical type comprise a rod (20) rigid with said piston and emerging upperly from said chamber to support an idle roller (21) maintained by elastic means against the profiled contour of a single fixed upper cam (24).

12. A device as claimed in claim 11, characterised in that said elastic means comprise a spring (25) positioned within said chamber (8) and maintained elastically compressed between the lower surface of said piston (9) and the base of the chamber (8).

13. A device as claimed in claim 1, characterised in that said body also comprises means (15) for detaching said annular blank or ring (41).

14. A device as claimed in claim 13, characterised in that said means (15) are of pneumatic type.

15. A device as claimed in claim 14, characterised in that said means (15) of pneumatic type are associated with said movable body and comprise at least one pressurized air feed conduit (150) which opens in proximity to said movable knife (10) and is connected to a suitable air delivery device.

16. A device as claimed in claim 1, characterised in that said movable body (6) rotates about a vertical axis.

17. A device as claimed in claim 1, characterised in that said movable body (6) is associated with a plate (2) maintained in rotation by a suitable drive unit.

18. A device as claimed in claim 1, characterised in that the lower end of said movable knife (10) is tapered.

19. (canceled)
